(19) United States
(12) Patent Application Publication
(10) Pub. No.: US 2014/0132912 A1
(43) Pub. Date: May 15, 2014

(54) HINGE STRUCTURE OF SPECTACLE FRAME

(71) Applicant: CHUAN PENG CHOU, TAIPEI CITY (TW)

(72) Inventor: CHUAN PENG CHOU, TAIPEI CITY (TW)

(21) Appl. No.: 13/676,409

(22) Filed: Nov. 14, 2012

(51) Int. Cl. G02C 5/22

(52) U.S. Cl. CPC G02C 5/2209
USPC 351/121

(57) ABSTRACT

An improved hinge structure of a spectacle frame allows fast hinge fabrication. The spectacle frame has two lugs each have an opening defined by a pendent insert. A pivot is formed with a trough for receiving and holding the pendent insert of the lug of the spectacle frame. A temple has a front end formed with resilient connecting members that each have a front end formed as a fastening claw for mating the pivot. The fastening claws of the temple are bent in are bent toward different directions, so as to grasp the pivot in the different directions, and hold the pendent insert of the lug received in the trough of the pivot in position. The opening of the lug allows the fastening claws of the connecting members of the corresponding temple to move therein, thereby forming the improved hinge structure that is assembled without using any screws and tools.

### BACKGROUND OF THE INVENTION

1. Technical Field

The present invention relates to hinges for spectacle frames, and more particularly, to an improved hinge structure of a spectacle frame.

2. Description of Related Art

Spectacles have long been the most popular vision correction tool, and stable wearing of spectacles relies on robust spectacle frames. We can see everywhere people use spectacle frames for myopia glasses, hyperopia glasses, presbyopia glasses and sunglasses to enhance vision or protect eyes.

In a typical spectacle frame, the temples and the frame body are connected through hinges that serve as joints. The existing hinge mainly uses a screw as its pivot, and such a screw, as a pivot, tends to loosen over repeated operation of the temple. When the screw loosens and is not timely screws to tight using a screwdriver, it can soon come off from the spectacle frame and get lost, making the spectacle frame unusable.

In view of the shortcomings of the prior arts, the inventor has used his years of experience to research and develop a hinge of a spectacle frame free from the problem of loosening screws and after numerous experiments and tries, an improved hinge structure without screws is well designed and herein disclosed.

### SUMMARY OF THE INVENTION

The present invention discloses an improved hinge structure of a spectacle frame, which includes lugs formed at two sides of the spectacle frame, and an opening of each said lug is formed with a pendent insert that is configured to be inserted into a trough formed on a pivot. Then a fastening claw formed on the front end of a connecting member of each said temple can be used to grasp the pivot, thereby accomplishing the fabrication. Therein, the opening of the lug allows the fastening claw of the connecting member on the corresponding temple to move therein, so that the disclosed hinge structure can be rapidly assembled without using any screws and tools.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is an exploded view of an improved hinge structure of a spectacle frame according to the present invention;

FIG. 2 is an assembled view of the improved hinge structure according to the present invention;

FIG. 3 shows another aspect of the pivot in the improved hinge structure improved hinge structure according to the present invention;

FIG. 4 shows still another aspect of the pivot in the improved hinge structure improved hinge structure according to the present invention;

FIG. 5 illustrate the fabrication of the improved hinge structure according to another embodiment of the present invention; and

FIG. 6 is a perspective view of the pivot according to another embodiment of the present invention.

### DETAILED DESCRIPTION OF THE INVENTION

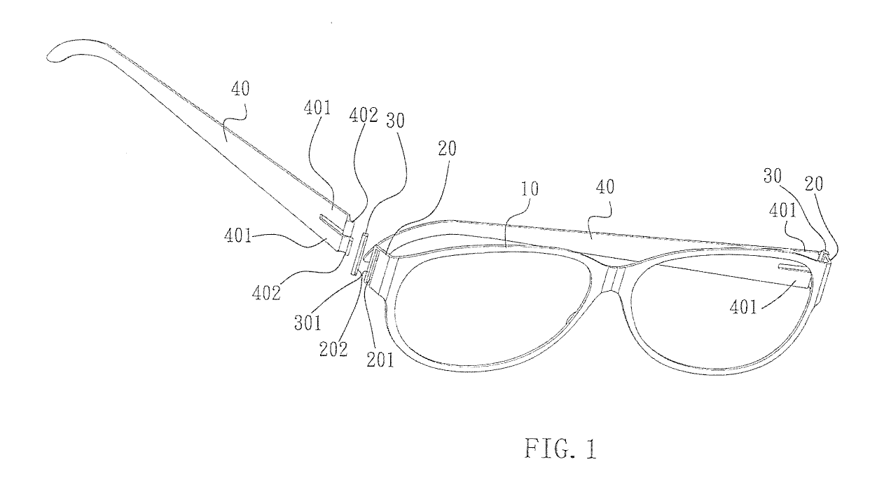

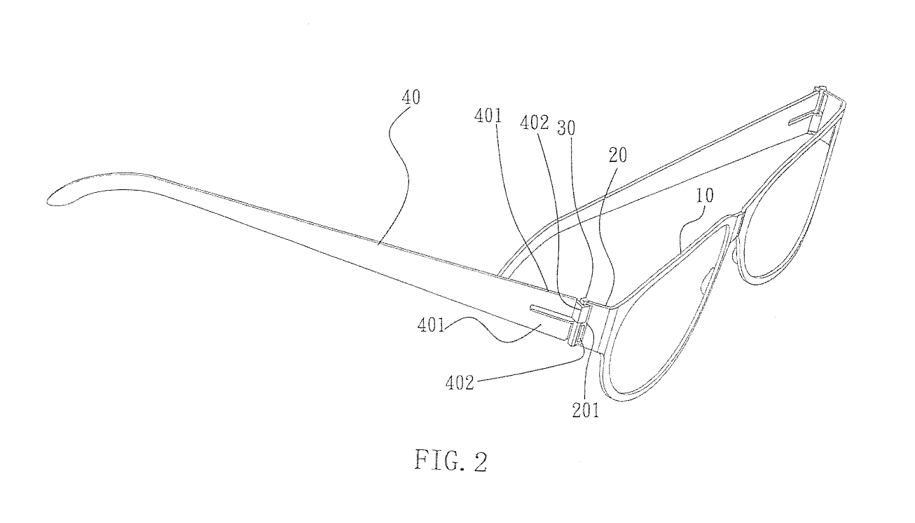

FIG. 1 is an exploded view of an improved hinge structure of a spectacle frame according to the present invention. As shown (referring also to FIG. 2), the disclosed hinge structure primarily comprises the following components.

A spectacle frame 10 has lugs 20 at its two sides. The lug 20 has an opening 201 defined by a pendent insert 202.

A pivot 30, which may be structurally a polygonal column or a round column, has a trough 301 formed thereon for receiving and holding the pendent insert 202 of the lug 20 of the spectacle frame 10 in position.

In addition, each of two temples 40 has a front end formed with a plurality of resilient connecting members 401. Each of the connecting members 401 has its front end bent and formed as a fastening claw 402 for mating the adjacent contacting surface on the pivot 30.

In the temple 40, the connecting member 401 and the fastening claw 402 are each provided in at least two.

Additionally, the fastening claws 402 of different said connecting members 401 are bent toward different directions, so as to grasp the pivot 30 in different directions and also hold the pendent insert 202 of the lug 20 received in the trough 301 of the pivot 30 well, thereby holding the pendent insert 202 within the trough 301 of the pivot 30 in position. Also, the opening 201 of the lug 20 allows the fastening claws 402 of the connecting members 401 for the temple 40 to move therein, so that when the temple 40 swings, the connecting members 401 and the fastening claws 402 are driven to move. The resilient nature of the connecting members 401 and the fastening claws 402 then allows these components to deform according to the profile of the pivot 30 by slighting opening with respect to each other and restoring to hold the pivot 30 firmly, thereby forming a hinge structure this is assembled without using any screws and tools.

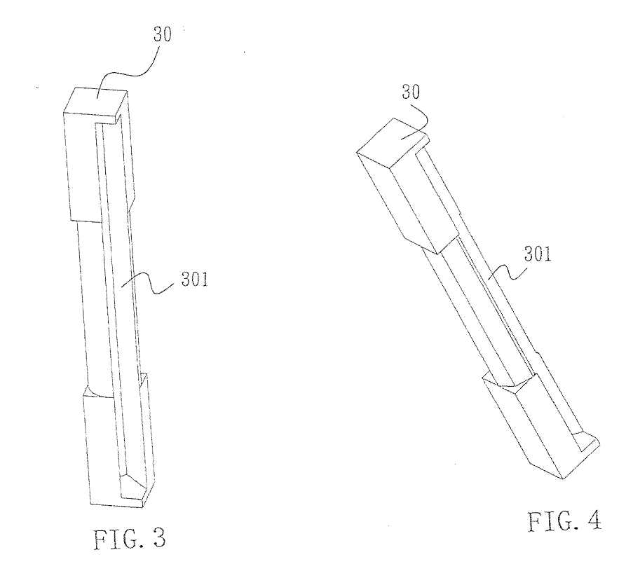

FIG. 3 shows another aspect of the pivot of the disclosed improved hinge structure. As shown, the pivot 30 may be a combination of polygonal columns and a round column and formed with a trough 301 for receiving (referring also to FIG. 1 and FIG. 2) the pendent insert 202 of the lug 20 on the spectacle frame 10.

FIG. 4 shows still another aspect of the pivot of the disclosed improved hinge structure. As shown, the pivot 30 may be a combination of different polygonal columns and formed with a trough 301 for receiving (referring also to FIG. 1 and FIG. 2) the pendent insert 202 of the lug 20 on the spectacle frame 10.

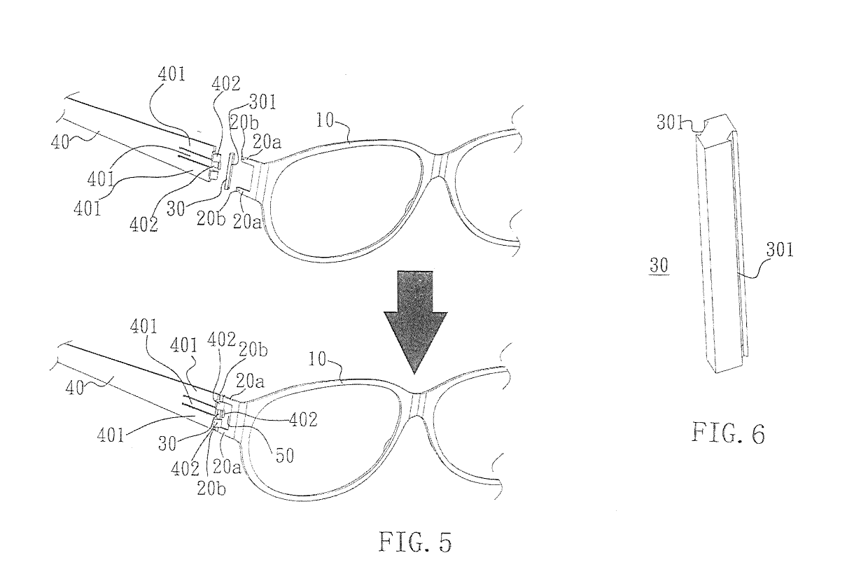

FIG. 5 is another embodiment of the improved hinge structure according to the present invention. As shown, in the spectacle frame 10, corresponding to each temple 40, there are two vertically aligned arms 20a each formed with a hook 20b.

A pivot 30 may be a polygonal column or a round column (also referring to FIG. 6) and has a through trough 301 for the hooks 20b of the arms 20a of the spectacle frame 10 to be inserted and hook its periphery so that an opening 50 is defined by the assembled pivot 30 and arms 20a.

In addition, each of two temples 40 has a front end formed with a plurality of resilient connecting members 401. Each of the connecting members 401 has its front end bent and formed as a fastening claw 402 for mating the adjacent contacting surface on the pivot 30.

In the temple 40, the connecting member 401 and the fastening claw 402 are each provided in at least two.

Additionally, the fastening claws 402 of different said connecting members 401 are bent toward different directions, so as to grasp the pivot 30 in different directions. When the temple 40 swings, the opening 50 defined by the hooks 20b of the arm 20a of the spectacle frame 10 and the pivot 30 allows the fastening claws 402 of the connecting members 401 to move therein.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

1. An improved hinge structure of a spectacle frame, being characterized in having:
a spectacle frame having two lugs formed at two sides thereof, the lug being formed with an opening defined by a pendent insert;
two pivots, each having a trough for receiving and holding the pendent insert of the lug of the spectacle frame; and
two temples, each having a front end formed with a plurality of resilient connecting members, and each connecting member having a front end bent and formed as a fastening claw mating an adjacent contacting surface on the pivot;
wherein, the fastening claws of the connecting members of each said temple are bent toward different directions, so as to grasp the pivot in the different directions, and hold the pendent insert of the lug received in the trough of the pivot in position, thereby retaining the pendent insert in the trough of the pivot without displacement, and
wherein, the opening of the lug allows the fastening claws of the connecting members of the corresponding temple to move therein, so that when the temple swings, the connecting members and the fastening claws are driven to move, and the connecting members and the fastening claws have a resilient nature that allows the fastening claws to deform according to a profile of the pivot by slighting opening with respect to each other and restoring to hold the pivot firmly.

2. An improved hinge structure of a spectacle frame, being characterized in having:
a spectacle frame having two sides each provided with two vertically aligned arms and each said arm being formed with a hook;
two pivots, each having a through trough for allowing the hooks of the arms of the spectacle frame to be inserted therein and then define an opening; and
two temples, each having a front end formed with a plurality of resilient connecting members, and each connecting member having a front end bent and formed as a fastening claw mating an adjacent contacting surface on the pivot;
wherein, the fastening claws of the connecting members of each said temple are provided in a number of at least two; and
wherein, the fastening claws of the connecting members of each said temple are bent toward different directions, so as to grasp the pivot in the different directions, and when the temple swings, the opening defined by the hooks of the arms of the spectacle frame and the pivot allows the fastening claws of the connecting members to move therein.

3. The improved hinge structure as claimed in claim 1, wherein the pivot is a polygonal column, a round column, a combination of a polygonal column and a round column, or a combination of columns of different polygonal columns.

4. The improved hinge structure as claimed in claim 1, wherein the fastening claws and the connecting members of each said temple are each provided in a number of at least two.

5. The improved hinge structure as claimed in claim 2, wherein the pivot is a polygonal column, a round column, a combination of a polygonal column and a round column, or a combination of columns of different polygonal columns.

6. The improved hinge structure as claimed in claim 2, wherein the fastening claws and the connecting members of each said temple are each provided in a number of at least two.
